(19) United States
(12) Patent Application Publication
(10) Pub. No.: US 2008/0248285 A1
(43) Pub. Date: Oct. 9, 2008

(54) Polyester Compositions Having High Dimensional Stability

(75) Inventor: Rodolfo Agustin Flores, Shelby, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.AR.L., Wilmington, DE (US)

(21) Appl. No.: 11/817,709

(22) PCT Filed: Mar. 8, 2005
(86) PCT No.: PCT/US05/07541

§ 371 Date: Sep. 4, 2007

(51) Int. Cl. B32B 5/16; C08K 3/34

(52) U.S. Cl. 428/324; 524/449

(57) ABSTRACT

The present invention relates to thermoplastic compositions having; high dimensional stability at high temperatures. In particular it is directed to polyester compositions containing mica for use in dual-ovenable trays and clear lids for hot food containers. According to one embodiment, the present invention is directed to a polyester composition comprising a polyester containing greater than about 2 to less than about 10 weight % of a mica filler. According to another embodiment of the present invention the mica containing polyester is prepared by the addition of the mica during polymerization, using a buffer to minimize diethylene glycol formation. According to another embodiment of the present invention, the polyester composition containing greater than 2 to less than 10 weight % mica also contains an additive package of impact modifier, nucleating agent and pigment in a concentration from about 5 weight % to 20 weight of the total composition. According to another embodiment of the present invention, the polyester composition containing mica is thermoformed into a container, such as a food tray.

### BACKGROUND OF THE INVENTION

1) Field of the Invention

This invention relates to thermoplastic polyester compositions having high dimensional stability at elevated temperatures. In particular it is directed to polyester compositions containing mica for use in dual-ovenable trays and clear lids for hot food containers. The compositions typically contain greater than 2 wt. % mica, but less than about 10 wt. %. Moreover, the size of the particles of mica are in the range from about 10 to about 300 microns, and it has an aspect ration of greater than about 10. Additionally, the compositions optionally contain sodium acetate in the range of about 0.05 to about 0.2 wt. % of the composition as a buffer. The mica is introduced during the process of making polyester either at the beginning of ester interchange or at the end of the ester interchange.

2) Prior art

It is well known in the field of engineering plastics to use fillers in order to improve the physical properties of molded parts. Fillers increase the tensile strength, stiffness, impact resistance, toughness, heat resistance and reduce creep and mold shrinkage. Fillers are typically used at loadings of 20 to 60% by weight of the plastic. Typical fillers are glass fibers, carbon/graphite fibers, ground micas, talc, clays, calcium carbonate and other inorganic compounds such as metallic oxides. U.S. Pat. No. 3,764,456 to Woodhams discloses the use of micas with aspect ratios of greater than 30, and from 10 to 70% by volume, of a composite to improve the modulus and strength of the composite.

U.S. Pat. No. 4,257,929 to Borman discloses polybutylene terephthalate (PBT) resins reinforced with mica coated with poly(tetrafluoroethylene) resin. The preferred amount of coated filler is 15 to 45 parts by weight of the total composition. Improvements in impact strength, heat distortion temperature and flexural strength were observed. U.S. Pat. No. 4,536,425 to Hekal discloses a method of preparing a resin having improved gas permeability by preferably using 30 to 50% by weight mica, of particle size greater than 100 microns, which is cleaved during melt blending to increase its aspect ratio.

U.S. Pat. No. 4,693,941 to Ostapenchenko discloses polyethylene terephthalate (PET) compositions containing a small amount of a terpolymer of ethylene and reinforced with a mineral material having an aspect ratio of at least 10. The reinforcing filler is used at a 10-50 weight % level and the composition molded into thermoformed articles for use in automotive applications.

U.S. Pat. No. 4,874,809 to Keep discloses a polyester composition for injection molded articles having low warpage. The composition is a blend of polyester, poly(cyclohexene-dimethylene terephthalate) with glass fibers and mica. The reinforcing fillers being in an amount of 10 to 25 weight % of the total composition.

U.S. Pat. No. 5,300,747 to Simon discloses a composite material for use in a microwave oven by the inclusion of a particulate dielectric material having a dielectric constant in a range of 5 to 8 and a particle size of 1 to 10 microns. Mica is used at a 25 weight loading as an example.

Japanese Patent Kokai Application 63-148030 to Hori et al. relates to a PET ovenable food tray containing 10 to 45 weight % mica having an average diameter of from 10 to 300 microns and an average aspect ratio from 10 to 45. The mica was used to improve the heat resistance of a thermoformed PET tray, to eliminate large thick spots that occur during thermoforming and to improve the gas (steam) barrier of the tray. Hori teaches that at mica levels below 10 weight % these problems are not solved. The preferred range is 20 to 40 weight % mica.

Japanese Patent Kokai Application 2003-292 748 to Keiichi discloses the use of mica particles to reduce the gas permeability of PET bottles. The amount of mica used was in the range of 0.5 to 2 weight %, higher loadings produced hazy bottles.

U.S. Pat. No. 5,342,401 to Dalgewicz et al. discloses a moldable polyester composition for containers having improved gas barrier properties and low thermal shrinkage. This was achieved by the controlled heating and cooling step in the thermoform mold.

U.S. Pat. Nos. 5,344,912 and 6,169,143 to Dalgewicz et al. disclose polyester compositions with improved impact properties, oxygen permeability and dimensional stability by including impact modifiers. Articles made from these compositions are useful for dual-ovenable containers.

U.S. Pat. No. 6,576,309 to Dalgewicz et al. discloses polyester compositions with improved molding properties, high dimensional and temperature resistance. This was accomplished by blending an ethylene acrylate copolymer, and optionally a compatibilizer/emulsifier/surfactant, into the polyester. These compositions were used as dual-ovenable containers. Dalgewicz does not give any examples, but repeating his description gave thermoformed trays that were deficient in high temperature stability.

There is therefore a need for a polyester composition that meets the stringent requirements of a dual-ovenable container. Dual-ovenable means that the food in the container can be heated in a microwave or conventional oven. There is also a need for a more thermal dimensional stability lid for hot food containers, for example domes used for cooked poultry. There is also a need for these articles to have improved oxygen barrier properties.

### SUMMARY OF THE INVENTION

According to one embodiment, the present invention is directed to a polyester composition comprising a polyester containing from greater than 2 but less than 10 weight % of a mica filler.

According to another embodiment of the present invention the mica containing polyester is prepared by the addition of the mica during polymerization, using a buffer to minimize the formation of diethylene glycol in the polyester

According to another embodiment of the present invention, the polyester composition containing greater than 2 but less than 10 weight % mica also contains an additive package of impact modifier, nucleating agent and pigment in a concentration from about 5 weight % to 20 weight % of the total composition. According to another embodiment of the present invention, the polyester composition containing mica is thermoformed into a container, such as a food tray.

### DETAILED DESCRIPTION OF THE PREFERRED EMBODIMENTS

Contrary to the teachings of the prior art it has been found that significant improvements in heat dimensional stability of polyester articles can be achieved by the addition of low levels (greater than 2, but less than 10 weight %) of mica. A possible explanation is that there are functional groups (quaternary amino), or residual hydroxyl groups, present in micas that can effect a chemical reaction of the polyester at the interface.

Generally polyesters or copolyesters can be prepared by one of two processes, namely: (1) the ester process and (2) the acid process. The ester process is where at least one dicarboxylic ester (such as dimethyl terephthalate, DMT) is reacted with at least one diol (such as ethylene glycol (EG)) in an ester interchange reaction. Because the reaction is reversible, it is generally necessary to remove the alcohol (methanol when dimethyl terephthalate is employed) to completely convert the raw materials into monomer. Monomers so prepared contain mixtures of short chain oligomers and in some cases small amounts of the starting materials. Certain catalysts are well known for use in the ester interchange reaction. In the past, catalytic activity was then sequestered by introducing a phosphorus compound, for example polyphosphoric acid, at the end of the ester interchange reaction. Primarily the ester interchange catalyst was sequestered to prevent yellowness from occurring in the polymer.

Then the monomer undergoes polycondensation and the catalyst employed in this reaction is generally an antimony, germanium, or titanium compound, or a mixture of these or other similar well known metal compounds.

In the second method for making polyester or copolyester, at least one dicarboxylic acid (such as terephthalic acid) is reacted with at least one diol (such as ethylene glycol) by a direct esterification reaction producing monomer and water. Monomer so prepared contains mixtures of short chain oligomers and in some cases small amounts of the starting materials. This reaction is also reversible like the ester process and thus to drive the reaction to completion one must remove the water. In most cases the direct esterification step does not require a catalyst. The monomer then undergoes polycondensation to form polyester just as in the ester process, and the catalyst and conditions employed are generally the same as those for the ester process. Suitable polyesters are produced from the reaction of a diacid or diester component comprising at least 65 mol-% terephthalic acid or C₂-C₄ dialkylterephthalate, preferably at least 70 mol-%, more preferably at least 80 mol-%, even more preferably, at least 90 mol-% of the acid moieties in the product, and a diol component comprising at least 65% mol-% ethylene glycol, or C₂-C₂₀ diglycols preferably at least 70 mol-%, more preferably at least 80 mol-%, even more preferably at least 95 mol-% of the diol moieties in the product. It is also preferable that the diacid component is terephthalic acid and the diol component is ethylene glycol, thereby forming polyethylene terephthalate (PET). The mole percent for all the diacid components totals 100 mol-%, and the mole percentage for all the diol component totals 100 mol-%.

Where the polyester components are modified by one or more diol components other than ethylene glycol, suitable diol components of the described polyester may be selected from 1,4-cyclohexanedimethanol; 1,2-propanediol; 1,4-butanediol; 2,2-dimethyl-1,3-propanediol; 2-methyl-1,3-propanediol (2 MPDO); 1,6-hexanediol; 1,2-cyclohexanediol; 1,4-cyclohexanediol; 1,2-cyclohexanedimethanol; 1,3-cyclohexanedimethanol, and diols containing one or more oxygen atoms in the chain, e.g., diethylene glycol, triethylene glycol, dipropylene glycol, tripropylene glycol or mixtures of these, and the like. In general, these diols contain 2 to 18, preferably 2 to 8 carbon atoms. Cycloaliphatic diols can be employed in their cis or trans configuration or as a mixture of both forms. Preferred modifying diol components are 1,4-cyclohexanedimethanol or diethylene glycol, or a mixture of these.

Where the polyester components are modified by one or more acid components other than terephthalic acid, the suitable acid components (aliphatic, alicyclic, or aromatic dicarboxylic acids) of the resulting linear polyester may be selected, for example, from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, bibenzoic acid, trimelletic acid, or mixtures of these and the like. In the polymer preparation, it is often preferable to use a functional acid derivative thereof such as the dimethyl, diethyl, or dipropyl ester of the dicarboxylic acid. The anhydrides or acid halides of these acids also may be employed where practical. These acid modifiers generally retard the crystallization rate compared to terephthalic acid. Most preferred is the copolymer of PET and isophthalic acid. Generally the isophthalic acid is present from about 0.5 to about 10 mole %, and preferably about 1.0 to 7 mole % of the copolymer.

In addition to polyester made from terephthalic acid (or dimethyl terephthalate) and ethylene glycol, or a modified polyester as stated above, the present invention also includes the use of 100% of an aromatic diacid such as 2,6-naphthalene dicarboxylic acid or bibenzoic acid, or their diesters, and a modified polyester made by reacting at least 85 mol-% of the dicarboxylate from these aromatic diacids/diesters with any of the above comonomers.

The polyester used in this invention preferably have an intrinsic viscosity (IV) of greater than 0.6, and more preferably greater than 0.75. The higher molecular weight gives higher strength to the resultant articles.

Higher IV polyesters can be obtained by solid state polymerization (SSP) of the lower IV polyester prepared by melt polymerization. Amorphous and or partially crystalline chips, prepared by standard melt polymerization procedures, are solid phase polymerized in one of the many ways known in the art, for example, by heating, with tumbling, in a batch vacuum tumble dryer or by passing continuously through a column in the presence of an inert gas, to increase the molecular weight.

The type of mica used in the present invention is not limited to any particular types. Muscovite, phlogopite, biotite, paragonite or synthesized mica may be used. Surface treated (silane, titanate or amino-) micas may also be used. Wet ground muscovite is preferred.

The average mica particle size used in the present invention is in the range of from about 10 to about 300 microns (μm), preferably in the range from about 10 to about 150 μm, and more preferably in the range of about 10 to about 100 μm. Articles molded from polyesters containing mica having a particle size less than about 10 μm exhibit insufficient thermal dimensional stability. Articles molded from polyesters containing mica particles greater than about 300 μm are inferior in appearance and contain voids which occur during the molding process.

The aspect ratio of the mica used in the present invention needs to be higher than about 10, preferably above about 25, and most preferably above about 50. There is no upper limit on aspect ratio, but below about 10 molded articles from this polyester composition exhibit insufficient thermal dimensional stability.

The amount of mica used in the present invention is greater than 2 but less than 10 weight % of the polyester composition. Below about 2 wt. % insufficient thermal stability in the molded article is exhibited, and above about 10 wt. % the molded article exhibits increased brittleness.

The mica is preferably slurried at a 30 to 40 wt. % concentration in ethylene glycol. This slurry is added at the beginning or end of the esterification step. To prevent an increase in the diethylene glycol (DEG) of the polyester a buffer such as sodium acetate may be employed, preferably in the range of about 0.05 to about 0.2 wt. % of the initial charge of raw materials.

Although master batches containing up to about 30 wt. % mica can be prepared for let-down to the desired level during the molding process, it was found that superior properties were obtained when the required amount of mica was added during polymerization.

With regard to dual-ovenable trays, there is no limitation with regards to adding plasticizers, nucleating agents, impact modifiers, mold release agents, stabilizers or colorants to improve the thermoforming process or the resultant properties of the trays. Nor are there limitations to the use of silane coupling agents or various types of dispersants in order to improve the bonding of the mica to the polyester matrix, or the dispersibility of the mica in the polyester during polymerization. With regard to clear food containers, these additives can also be used as long as they do not significantly affect the clarity.

Typical additive packages for dual-ovenable trays are disclosed in U.S. Pat. Nos. 5,409,967 and 6,576,309 which are hereby incorporated by reference. Food containers such as trays and lids are generally manufactured by a thermoforming process, although injection and compression molding can be used. In the thermoforming process the polyester composition is melted and mixed in an extruder and the molten polymer is extruded into a sheet and cooled on a roller. Thermoforming, also called vacuum forming, is the heating of a thermoplastic sheet until it is pliable and stretchable, and then forcing the hot sheet against the contours of a mold by using mechanical force and vacuum. When held to the shape of the mold by atmospheric pressure and allowed to cool, the plastic sheet retains the mold's shape and detail. Improved heat resistance can be achieved by annealing the article in the mold at temperatures greater than 100° C., and preferably greater than 130° C. For clear articles it is important that the time and temperature in the mold is optimized to obtain the maximum crystallinity without haziness due to large spherulitic crystals.

The articles of the present invention can also be manufactured with multiple layers, one of which is the polymer composition of the invention, by lamination of the sheets or co-extrusion of the sheet.

### Test Procedures

The Intrinsic Viscosity (IV) of the pellets was measured according to ASTM D4603-03.

The diethylene glycol (DEG) content (wt. %) of the polymer is determined by hydrolyzing the polymer with an aqueous solution of ammonium hydroxide in a sealed reaction vessel at 220±5° C. for approximately two hours. The liquid portion of the hydrolyzed product is then analyzed by gas chromatography. The gas chromatography apparatus is a FID Detector (HP5890, HP7673A) from Hewlett Packard. The ammonium hydroxide is 28 to 30% by weight ammonium hydroxide from Fisher Scientific and is reagent grade.

The carboxyl end group (CEG) value of a polymer is determined by dissolving a sample of the polymer in reagent grade benzyl alcohol and titrating to the purple end point of phenol red indicator with 0.03 N sodium hydroxide/benzyl alcohol solution. The results are reported in millimoles sodium hydroxide per kilogram (mmol/kg) of the sample.

The Heat Deflection Temperature (HDT) was measured according to ASTM D648-01, method A, at a stress of 0.455 Mpa. The specimens had a length of 127 mm, a width of 13 mm and a depth of 13 mm.

The Deflection Temperature Under Load (DTUL) was recorded using a DMA Q800 instrument (TA Instruments, New Castle, Del., USA) by measuring the temperature at which the deflection of the specimen (thin film, 15 mm long, 13 mm wide and 0.5 mm thick) corresponded to the strain (0.121%) that would be induced with the ASTM load of 0.455 Mpa. The heating rate was 2° C./minute.

The Storage Modulus was measured using a DMA Q800 instrument (TA Instruments, New Castle, Del., USA) on a thin film sample using a heating rate of 2° C./minute and a frequency of 10 Hz.

The Tensile Properties were measured according to ASTM D638-03, using a Type I specimen.

The Gardner Impact was measure according to ASTM D5420-04, using GA geometry.

The oxygen flux of film samples, at zero percent relative humidity, at one atmosphere pressure, and at 25° C. was measured with a Mocon Ox-Tran model 2/20 (MOCON Minneapolis, Minn.). A mixture of 98% nitrogen with 2% hydrogen was used as the carrier gas, and 100% oxygen was used as the test gas. Prior to testing, specimens were conditioned in nitrogen inside the unit for a minimum of twenty-four hours to remove traces of atmospheric oxygen. The conditioning was continued until a steady base line was obtained where the oxygen flux changed by less than one percent for a thirty-minute cycle. Subsequently, oxygen was introduced to the test cell. The test ended when the flux reached a steady state where the oxygen flux changed by less than 1% during a 30 minute test cycle. Calculation of the oxygen permeability was done according to a literature method for permeation coefficients for PET copolymers, from Fick's second law of diffusion with appropriate boundary conditions. The literature documents are: Sekelik et al., Journal of Polymer Science Part B: Polymer Physics, 1999, Volume 37, Pages 847-857. The second literature document is Qureshi et al., Journal of Polymer Science Part B: Polymer Physics, 2000, Volume 38, Pages 1679-1686. The third literature document is Polyakova, et al., Journal of Polymer Science Part B: Polymer Physics, 2001, Volume 39, Pages 1889-1899. The oxygen permeability is stated in units of nmol/m.s.GPa.

A Differential Scanning Calorimeter (Perkin Elmer DSC-2, Norwalk, Conn., USA) was used the measure the relative crystallization of the polymers. 10 mg of the polymer was heated at 10° C./min. to 300° C., held at this temperature for 2 minutes, and cooled at 10° C./min. The peak of the crystallization exotherm on cooling (T_{ch}) was measured.

### Example 1

Polyesters (PET) were prepared using a conventional DMT process, followed by SSP, containing various fillers at different concentrations to give a final IV of 0.85. The suppliers of these fillers are given in Table 1.

TABLE 1

| Filler | Company |
|---|---|
| Calcium Carbonate | Nyacol, Ashland, MA USA |
| Silicon Dioxide | Nyacol, Ashland, MA USA |
| Mica | Georgia Industrial Minerals, Sandersville, GA USA |
| Zinc Oxide | Bayer, Leverkusen, Germany |

The filled polymers were molded into 0.5 mm thick films. The films were tested in the amorphous state, and after annealing for 150° C. for one hour in a vacuum oven. The storage moduli of these films were measured at 30° C. and the results set forth in Table 2.

TABLE 2

| | Storage Modulus, MPa | |
|---|---|---|
| Sample | Amorphous | Crystallized |
| Control | 531 | 1123 |
| Calcium carbonate, 3%, 0.4 μm | 495 | 1470 |
| Calcium carbonate, 3%, 1.2 μm | 650 | 1738 |
| Calcium carbonate, 5%, 2 μm | 681 | 1794 |
| Silicon dioxide, 2%, 0.1 μm | 620 | 1791 |
| Zinc oxide, 2%, 35 nm | 427 | Not measured |
| Mica, 2%, 5 μm | 728 | 1373 |
| Mica, 5%, 10 μm | Not measured | 2001 |

Based on the storage modulus (stiffness) of the annealed samples, which simulated the annealing process during thermoforming, additional samples of selected fillers were prepared with a 1 weight % loading. Specimens were prepared from these polymers and the heat deflection temperature (HDT) was measured. The results are set forth in Table 3.

TABLE 3

| Filler | Particle size, μm | Aspect ratio | HDT, ° C. |
|---|---|---|---|
| Control | | | 142.0 |
| Mica | 0.5 | ~2 | 143.8 |
| Mica | 10 | ~30 | 164.2 |
| Mica | 18 | ~60 | 165.9 |
| Calcium carbonate | 2 | ~1 | 162.6 |

The improvement in HDT was observed with mica when the particle size was greater than about 10μ, with as aspect ratio of greater than about 30.

### Example 2

A polyester was prepared according to the procedure of Example 1 containing 1 wt. % of a 10 μm mica (aspect ratio˜30). Specimens were prepared from the amorphous polymer and polymer that had been annealed at 150° C. overnight in a vacuum oven. The tensile properties were measured and the results set forth in Table 4.

TABLE 4

| | | Young's Modulus, | Strain at Max. |
|---|---|---|---|
| Sample | Condition | GPa | Load, % |
| Control | Amorphous | 1.06 | 8.4 |
| Mica, 1% | Amorphous | 1.26 | 6.7 |
| Control | Annealed | 1.27 | 14.4 |
| Mica, 1% | Annealed | 1.40 | 15.9 |

An improvement in Young's Modulus was observed in both the amorphous and annealed mica samples.

### Example 3

Three polyester resins, containing 2.1 wt. %, 10 μm mica, were prepared using a DMT process. Sample A was prepared with the addition of the mica slurry (30 wt. % in EG) at the beginning of ester interchange (EI) (with the initial charge of DMT, ethylene glycol and EI catalysts). Sample B was prepared with the addition of the mica slurry (30 wt. % in EG) after EI, prior to polymerization. Sample C was prepared in the same sequence as Sample B but with the addition of 0.1 wt. % sodium acetate, based on the weight of the initial charge, in the mica slurry. Sample D was prepared in the same sequence as Sample A but with the addition of 0.1 wt. % sodium acetate, based on the weight of the initial charge, in the mica slurry. The chemical properties of these polymers, compared to a control without mica, were measured, and the results set forth in Table 5.

TABLE 5

| Sample | IV, dl/g | DEG, wt. % | CEG, mmol/kg |
|---|---|---|---|
| Control | 0.55 | 0.7 | 23 |
| A | 0.55 | 1.4 | 39 |
| B | 0.55 | 3.8 | 89 |
| C | 0.56 | 0.5 | 21 |
| D | 0.61 | 0.8 | 18 |

Addition of the mica after EI gives high DEG (Sample B), which will lead to a lowering of the melting point and HDT, as well as an increase in CEG. The DEG and CEG were lowered by adding the mica at the beginning of EI (Sample A), but still gave DEG and CEG values greater than the control. It is believed that this increase is due to residual acidity in the mica. The addition of a buffer (Samples C and D) with the mica brought the DEG and CEG values back to normal.

### Example 4

A comparison of the Gardner Impact of polymers with different micas at different loadings prepared by the melt polymerization/solid state polymerization route (MP/SSP) and compounding was made. Compounding used a ZSE-GL twin screw extruder (American Leistritz, Summerville, N.J., USA) with the 0.89 IV control polymer by the dry addition of the mica at the extruder throat. Discs were molded and crystallized overnight at 150° C. The results are set forth in Table 6.

TABLE 6

| Mica, μm | Mica, wt. % | Process | IV | Mean failure Energy, J |
|---|---|---|---|---|
| Control | 0 | MP/SSP | 0.79 | 1.47 |
| 10 | 2.1 | MP/SSP | 0.78 | 1.41 |
| 10 | 5.0 | MP/SSP | 0.74 | 1.08 |
| 20 | 5.0 | MP/SSP | 0.86 | 1.33 |
| Control | 0 | Compounded | 0.63 | 0.99 |
| 10 | 2.1 | Compounded | 0.64 | 1.11 |
| 10 | 5.0 | Compounded | 0.62 | 1.12 |
| 20 | 5.0 | Compounded | 0.61 | 0.99 |

The loss in Gardner Impact is probably due to the loss in IV during compounding. Master batches of polymer containing up to 20 wt. % mica have been successfully prepared. They were not tested due to this observation that compounding had such a significant effect on IV loss.

### Example 5

The polymers containing 5 wt. % mica, 10 and 20 μm, prepared by MP/SSP in Example 4 were molded into films. These films were annealed for various times at 160° C. in an oven. The DTUL was measured on these films, and the results set forth in Table 7.

TABLE 7

| | | DTUL, ° C. | |
|---|---|---|---|
| | | 10 μm mica (aspect | 20 μm mica (aspect |
| Time, min. | Control | ratio ~30) | ratio ~60) |
| 30 | 104 | 105 | 117 |
| 60 | 110 | 118 | 123 |
| 90 | 114 | 130 | 139 |

The results demonstrate the advantage in annealed articles molded from larger diameter mica particles (higher aspect ratio).

### Example 6

Films of thickness in the range of 0.4 to 0.5 mm were prepared from polyesters containing various size mica particles at different loadings. These films were annealed at 160° C. for 1 hour. The oxygen permeability was measured and the results set forth in Table 8.

TABLE 8

| | | Oxygen Permeability, |
|---|---|---|
| Mica, μm | Mica, wt. % | nmol/m · s · GPa |
| Control | 0 | 11.8 |
| 10 (aspect ratio ~30) | 5 | 8.70 |
| 20 (aspect ratio ~60) | 5 | 7.82 |
| 10 (aspect ratio ~30) | 10 | 6.12 |

These results show that these mica particles significantly reduce the oxygen permeability of the films, the larger aspect ratio particles being better at a given loading.

### Example 7

The crystallization rate of polymers containing 1.0 and 2.1 wt. % of 10 μm mica (aspect ratio˜30) was measured, and the results set forth in Table 9.

TABLE 9

| Mica, wt % | T_{ch}, ° C. |
|---|---|
| 0 | 182.1 |
| 1 | 191.6 |
| 2 | 207.9 |

Although this Example is outside the claimed range, it demonstrates the higher T_{ch} with increasing mica content indicates a faster crystallization rate. This faster rate is of value in the annealing of thermoformed food trays.

Thus it is apparent that there has been provided, in accordance with the invention, a process that fully satisfied the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

1) A polyester resin composition for thermoforming articles, comprising: at least 70 weight % polyester, and greater than 2, but less than 10 wt. % mica, said composition having a DEG content less than 0.8 wt. %.

2) The polyester resin composition of claim 1, further containing impact modifier, nucleating agent and pigment in a concentration from about 5 weight % to 20 weight % of the total composition.

3) The polyester resin composition of claim 1, wherein said mica is in the range of from about 10 to about 300 microns (μm).

4) The polyester resin composition of claim 1, wherein said mica is in the range of about 10 to about 100 μm.

5) The polyester resin composition of claim 1, wherein said mica has an aspect ratio of higher than about 10.

6) The polyester resin composition of claim 1, wherein said mica preferably has an aspect ratio above about 25.

7) The polyester resin composition of claim 1, wherein said mica most preferably has an aspect ratio above about 50.

8) The polyester resin composition of claim 1, further containing sodium acetate in the range of about 0.05 to about 0.2 wt. % of said composition.

9) The polyester resin composition of claim 1 wherein said polyester contains 85 mole % or more of polyethylene terephthalate.

10) A method of making polyester resin composition, comprising reacting dicarboxylic acid or dicarboxylic ester with diol in an esterification step to form monomer, blending mica at the beginning of said esterification step, and reacting said monomer/mica in a polycondensation step.

11) A method of making polyester resin composition, comprising reacting dicarboxylic acid or dicarboxylic ester with diol in an esterification step to form monomer, blending mica with said monomer at the end of the esterification step, and reacting said monomer/mica in a polycondensation step.

12) The method of making polyester resin composition according to claim 10, wherein said mica is slurried at a 30 to 40 wt. % concentration in ethylene glycol.

13) The method of making polyester resin composition according to claim 10, by further comprising adding sodium acetate as a buffer to reduce the DEG in said composition, in the blending step in the range of about 0.05 to about 0.2 wt. % of said composition.

14) The method of making polyester resin composition according to claim 10, wherein said mica is in the range of from about 10 to about 300 microns (μm).

15) The method of making polyester resin composition according to claim 10, wherein said mica has an aspect ratio of higher than about 10.

16) The method of making polyester resin composition according to claim 10, wherein said mica has an aspect ratio above about 50.

17) The method of making polyester resin composition according to claim 10, further containing sodium acetate as a buffer to reduce the DEG in said composition, in the range of about 0.05 to about 0.2 wt. % of said composition.

18) The method of making polyester resin composition according to claim 10, further containing impact modifier, nucleating agent and pigment in a concentration from about 5 weight % to 20 weight % of the total composition.

19) The method of making a polyester resin composition according to claim 11, wherein said mica is in the range of from about 10 to about 300 microns (μm).

20) The method of making a polyester resin composition according to claim 11, wherein said mica has an aspect ratio of higher than about 10.

21) The method of making a polyester resin according to claim 10, wherein said polyester contains 85 mole % or more of polyethylene terephthalate.

22) A thermoformable article made from a polyester resin composition, comprising polyester including greater than 2, but less than 10 wt. % mica, said mica is in the range of from about 10 to about 300 microns (μm), and having an aspect ratio of higher than about 10; and a buffer to reduce the DEG in said composition.

23) The thermoformable article of claim 22, wherein said buffer is sodium acetate in the range of about 0.05 to about 0.2 wt. % of said composition.

24) The thermoformable article of claim 23, further containing impact modifier, nucleating agent and pigment in a concentration from about 5 weight % to 20 weight % of the total composition.

25) The thermoformable article of claim 22, wherein said polyester contains 85 mole % or more of polyethylene terephthalate.
